(19) United States
(12) Patent Application Publication
(10) Pub. No.: US 2009/0135458 A1
(43) Pub. Date: May 28, 2009

(54) Contact image sensor structure

(76) Inventors: Chia-Sung Tan, Taipei City (TW); Chih-Chen Ho, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,030

(22) Filed: Nov. 27, 2007

(51) Int. Cl. H04N 1/46

(52) U.S. Cl. 358/514

(57) ABSTRACT

A contact image sensor structure includes a body, a substrate, and a light source unit. The body has a first side surface and a second side surface. The body has a pin slot that passes through the first side surface and the second side surface. The second side surface has a light source receiving slot, and the light source receiving slot links with the pin slot. The substrate has a plurality of pads. The light source unit is fastened in the pin slot and the light source receiving slot. One end of the light source unit has a plurality of pins. The pins pass through the pin slot and contact the pads of the substrate. Thereby, the pins are electrically connected with the pads without welding. The life time and the reliability of the contact image sensor are enhanced, and the assembling process is simplified.

### BACKGROUND OF THE INVENTION

1. Field of the Invention

The present invention relates to a contact image sensor structure. In particular, this invention relates to a connecting structure between the light source and the substrate of the sensor.

2. Description of the Related Art

FIGS. 1 and 2 show the contact image sensors (CIS) of the prior art. The contact image sensor includes a body 1a, a substrate 2a, a light source unit 3a and a rod lens 4a. The body 1a has a first side surface 11a and a second side surface 12a that are opposite to each other. The light source unit 3a and the rod lens 4a are respectively glued and fastened onto the second side surface 12a. The substrate 2a is locked on the first side surface 11a via a plurality of screws 5a. One end of the light source unit 3a has a plurality of pins 31a. The body 1a has a pin slot 13a that passes through the first side surface 11a and the second side surface 12a. The pins 31a pass through pin slot 13a and one end of the pin 31a is welded with a pad 21a on the substrate 2a. Thereby, the light source unit 3a is electrically connected with substrate 2a.

Although the welding process can fasten the light source unit 3a onto the substrate 2a and be electrically connected with the substrate 2a, the life time of the light source unit 3a is affected by the temperature of the welding point. The light source unit 3a may be damaged so that the cost increases. Furthermore, the welding oil is required when the welding process is performed so that function of the sensing element on the substrate 2a is affected.

### SUMMARY OF THE INVENTION

One particular aspect of the present invention is to provide a contact image sensor structure that increases the life time of the contact image sensor, simplifies the assembling processes, and reduces the cost.

The contact image sensor structure includes a body, a substrate, and a light source unit. The body has a first side surface and a second side surface that are opposite to each other. The body has a pin slot that passes through the first side surface and the second side surface. The second side surface has a light source receiving slot, and the light source receiving slot links with the pin slot. The substrate is fastened onto the first side surface and covers one end of the pin slot. The substrate has a plurality of pads. The light source unit is fastened in the pin slot and the light source receiving slot. One end of the light source unit has a plurality of pins. The pins pass through the pin slot and contact the pads of the substrate.

The present invention has the following characteristics. The pins of the light source unit contact the pads of the substrate to achieve the electrical connection, without using the welding process. Therefore, both the light source unit damaged by the temperature of the welding point and the sensing element of the substrate affected by the welding oil are avoided. The life time and the reliability of the contact image sensor are increased. Because the welding process is not required for the assembling process, the assembling process for the contact image sensor is simplified, and the cost is reduced.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the contact image sensor of the prior art;

FIG. 2 is a perspective view of the substrate in FIG. 1 being assembled with the body of the prior art;

FIG. 3 is an exploded perspective view of the contact image sensor of the first embodiment of the present invention;

FIG. 4 is a top view of the body of the present invention;

FIG. 5 is a bottom view of the body of the present invention;

FIG. 6 is a perspective view of the substrate in FIG. 3 being heated and compressed with the body of the present invention;

FIG. 7 is a schematic diagram of the pins electrically connected with the substrate of the first embodiment of the present invention;

FIG. 8 is an exploded perspective view of the contact image sensor of the second embodiment of the present invention;

FIG. 9 is a schematic diagram of the pins electrically connected with the substrate of the second embodiment of the present invention;

FIG. 10 is an exploded perspective view of the contact image sensor of the third embodiment of the present invention;

FIG. 11 is a schematic diagram of the pins electrically connected with the substrate of the third embodiment of the present invention;

FIG. 12 is another schematic diagram of the pins electrically connected with the substrate in FIG. 11; and

FIG. 13 is a third schematic diagram of the pins electrically connected with the substrate in FIG. 11.

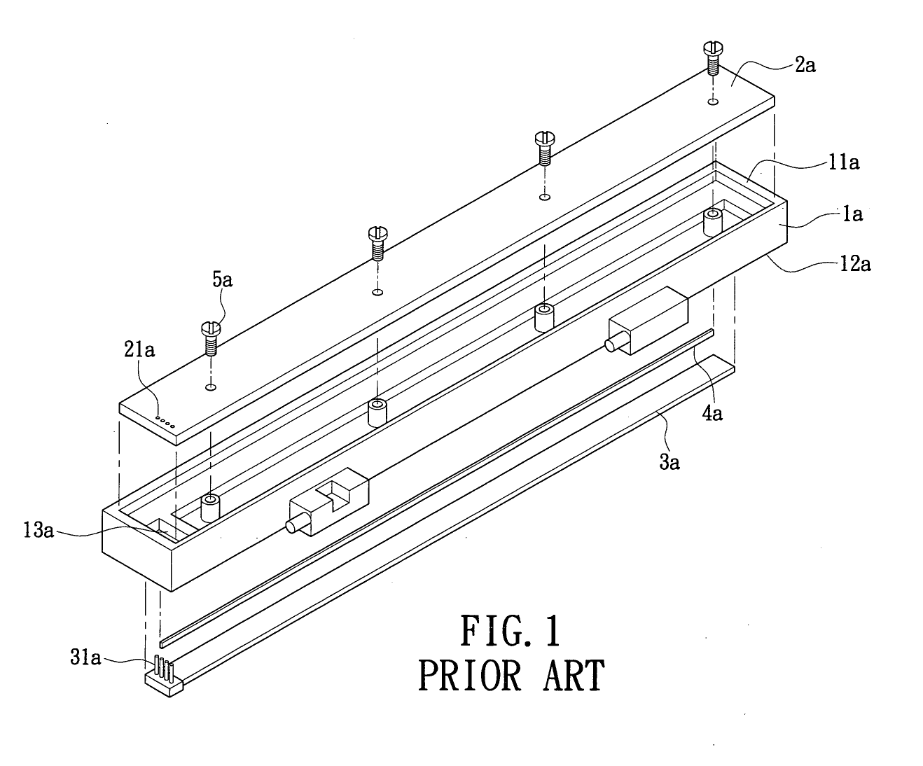

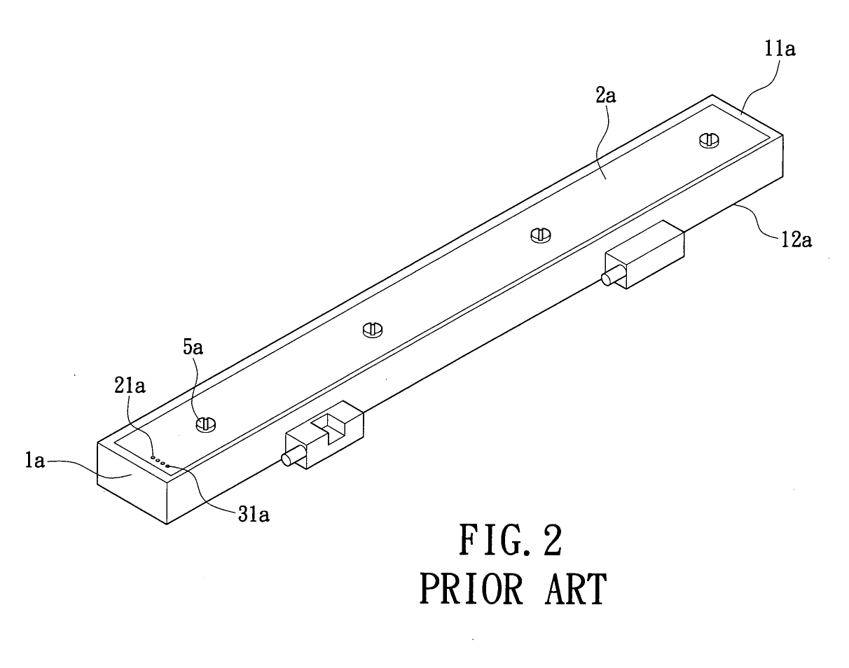

### DETAILED DESCRIPTION OF THE PREFERRED EMBODIMENTS

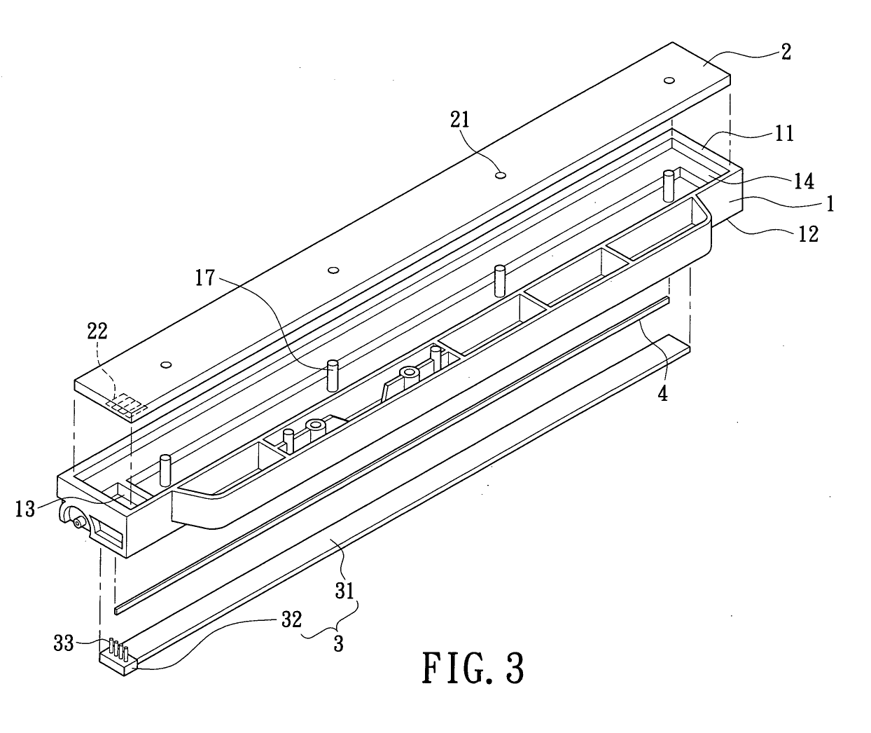

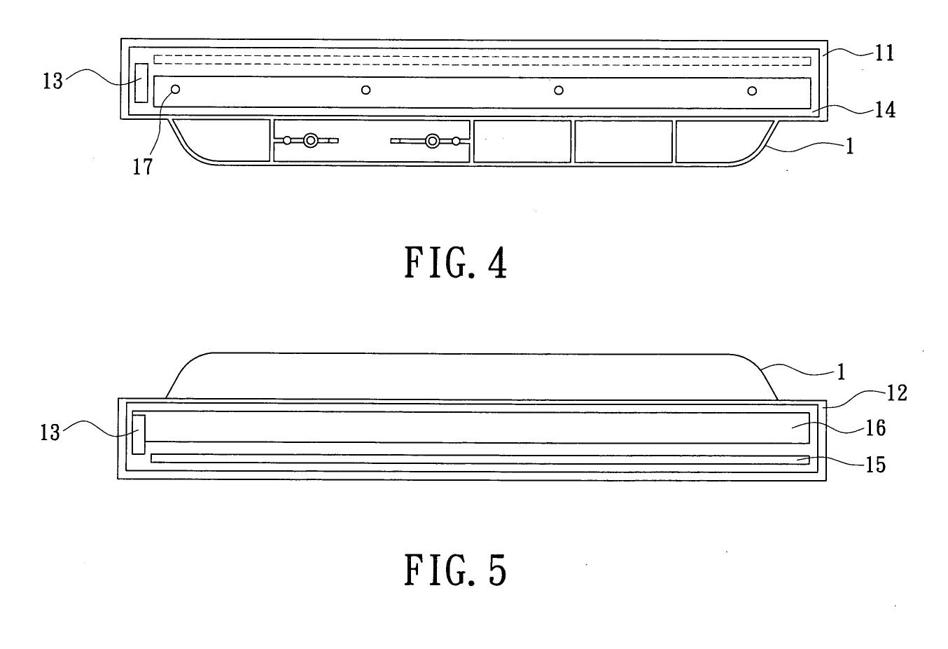

Reference is made to FIGS. 3-5. The contact image sensor structure includes a body 1, a substrate 2, a light source unit 3, and a lens 4. The body 1 has a first side surface 11 and a second side surface 12 that are opposite to each other. The body 1 has a pin slot 13 that passes through the first side surface 11 and the second side surface 12. The first side surface 11 has a substrate installing slot 14. The second side surface 12 has a lens receiving slot 15 and a light source receiving slot 16. The light source receiving slot 16 links with the pin slot 13.

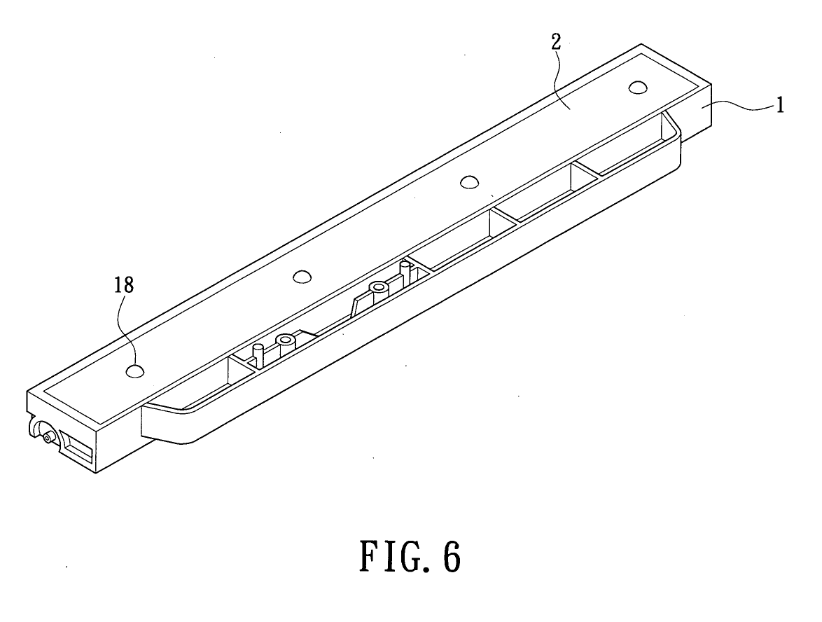

The substrate 2 is composed of sensing element and electronic elements that are positioned by an electronic positioning device and welded onto a circuit board. At the middle of the substrate installing slot 14, there is a plurality of convex fastening columns that are disposed at intervals and are integrated with body 1 into one piece. There is a plurality of fastening holes 21 disposed on the substrate 2 at intervals. After the fastening holes 21 of the substrate 2 are assembled with the fastening columns of the body 1, a heating and compression method is used for heating and melting the part of the fastening column that protrudes outside of the fastening hole to form a fastening head 18 (as shown in FIG. 6). Thereby, the substrate 2 is assembled with the body 1.

The lens 4 has a rod shape. The lens 4 is fastened into the lens receiving slot 15 by gluing. The light source unit 3 includes a light-guiding rod 31 and a hybrid of light source 32. The hybrid of light source 32 is electrically connected with the light-guiding rod 31. One side of the hybrid of light source 32 protrudes to form a plurality of pins 33. In the hybrid of light source 32, there is a flexible mechanism (not shown in the figure) that is connected with one end of the pins 33 so that the connection is flexible. Alternatively, the pins 33 made of flexible material also achieve the same effect.

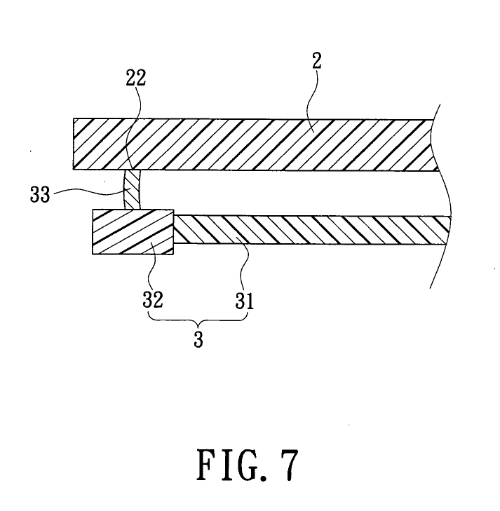

The second side surface 12 of the substrate 2 has a plurality of pads 22. The pads 22 are electrically connected with the conductive traces, the sensing element, and the electronic elements of the substrate 2. The light-guiding rod 31 and the hybrid of light source 32 are respectively fastened into the light source receiving slot 16 and the pin slot 13 by gluing. The pins 33 pass through the pin slot 13 to contact the pads 22 of the substrate 2 (as shown in FIG. 7). Thereby, the pins 33 are electrically connected with the pads 22 of the substrate 2. Because the pads merely need to be located at one side surface of the substrate 2 to electrically connect the pins 33, the substrate 2 can be a single surface board. The cost is reduced.

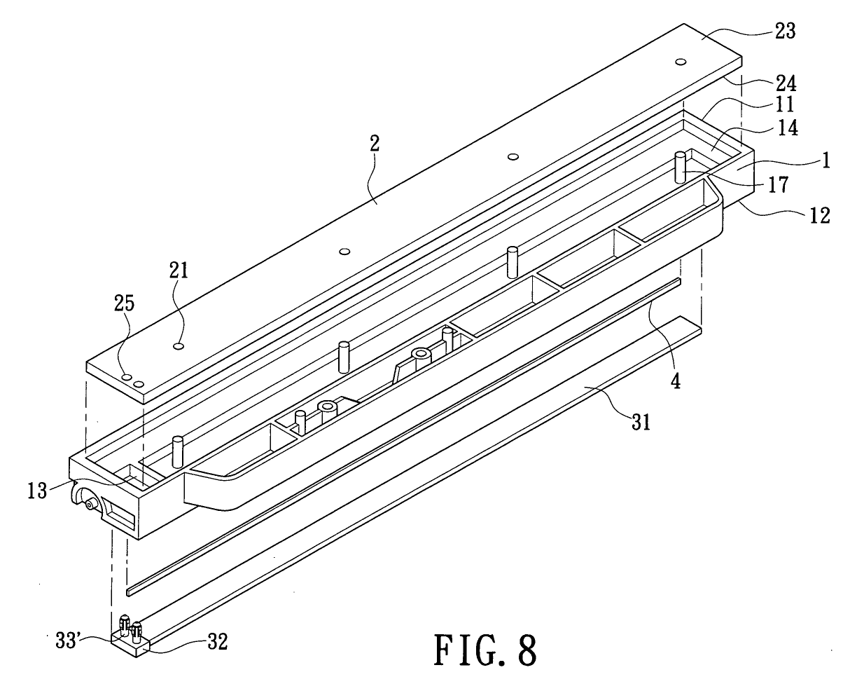

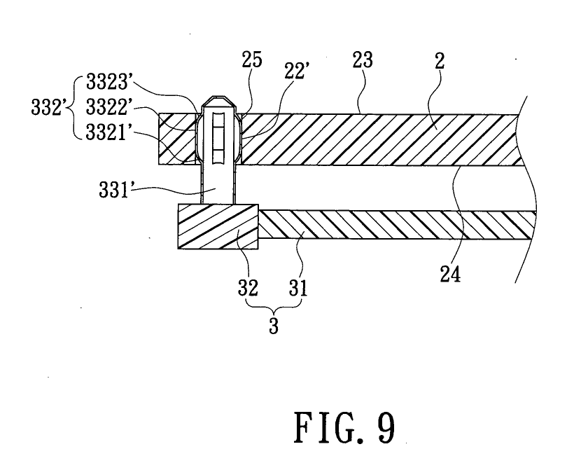

FIGS. 8 and 9 show the contact image sensor of the second embodiment of the present invention. The substrate 2 has a top surface 23 and a bottom surface 24. A plurality of through holes 25 are formed at one end of the substrate 2 that pass through the top surface 23 and the bottom surface 24. The pads 22′ are electroplated on the inner wall of the through holes 25 to form a conductive layer. The pins 33′ respectively pass through the through holes 25′, and each of the pins 33′ have a base portion 331′. A plurality of contact braces 332′ are connected with the exterior of the base portion 331′ at intervals. The contact brace 332′ includes a first curved portion 3321′, a contact portion 3322′ and a second curved portion 3323′. The first curved portion 3321′ extends away from the base portion 332′ in a curved manner. The contact portion 3322′ extends from the end of the first curved portion 3321′ that is distant from the base portion 332′ to the end of the second curved portion 3323′ that is distant to the base portion, the contact portion 3322′ being parallel to the base portion 332′. The contact portion 3322′ contacts the pads 22′ in the through hole 25 so that the substrate 2 is electrically connected with the light source unit 3. Furthermore, the shape of the contact brace 332′ is not limited to the above shape. Any contact brace 332′ that can contact the pad 22′ in the through hole 25 is within the scope of the present invention.

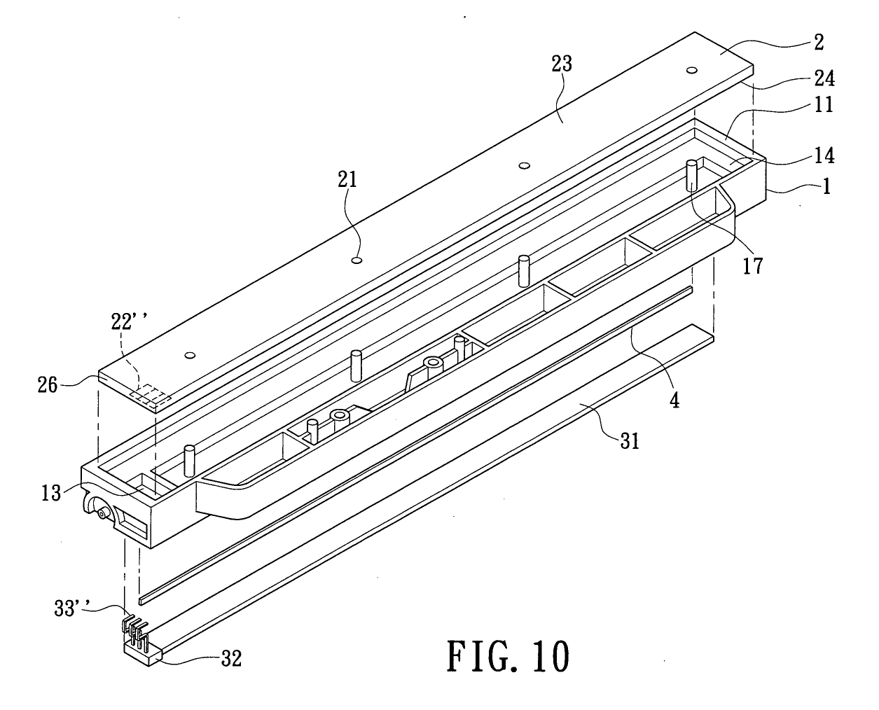

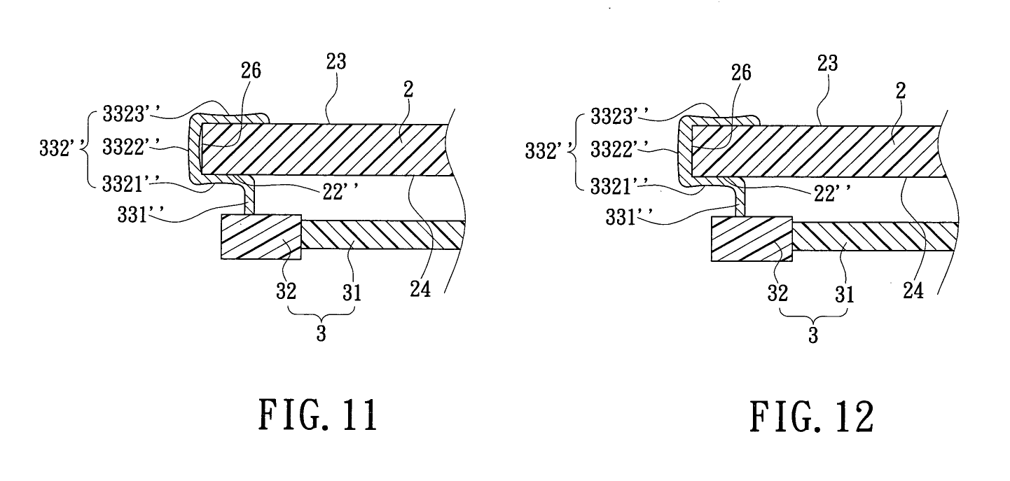

FIGS. 10 and 11 show the contact image sensor of the third embodiment of the present invention. The pins 33″ include a base portion 331″ and a holding portion 332″. The holding portion 332″ includes a first contact arm 3321″, a second contact arm 3322″ and a third contact arm 3323″. The first contact arm 3321″ extends away from one end of the base portion 331″. The second contact arm 3322″ extends from the end of the first contact arm 3321″ that is distant from the base portion 331″. The third contact arm 3323″ extends from the end of the second contact arm 3322″ that is distant from the first contact arm 3321″. The second contact arm 3322″ is thus located between the first contact arm 3321″ and the third contact arm 3323″. There is a plurality of pads 22″ on the bottom surface 24 of the substrate 2. The substrate 2 has a side wall 26 located between the top surface 23 and the bottom surface 24. The first contact arm 3321″ and the third contact arm 3323″ respectively contact the top surface 23 and the bottom surface 24. The first contact arm 3321″ is electrically connected with the pads 22″. The second contact arm 3322″ is adjacent to the side wall 26 of the substrate 2 or contact the side wall 26 of the substrate (as shown in FIG. 12). Furthermore, it merely needs to has the pads 22 on a single surface, the top surface 23 or the bottom surface 24, the goal of the pins 33″ electrically connecting the substrate 2 can be achieved. Therefore, the substrate 2 can be a single-layer board, and the cost is reduced. However, if the cost is not the concerned issue, both the top surface 23 and the bottom surface 24 can have the pads 22″.

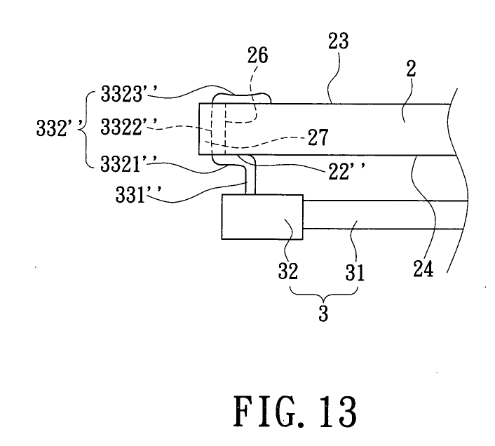

As shown in FIG. 13, the side wall 26 has a plurality of concave openings 27. The second contact arms 3322″ respectively are lodged in the openings 27.

From the contact image sensor of the above three embodiments, the pins 33, 33′, 33″ of the light source unit 3 contact the pads 22, 22′, 22″ of the substrate 2 to achieve the electrical connection, without the welding method. Therefore, the problems of the light source unit 3 damaged by the heat generated around the welding area and the sensing element in the substrate 2 affected by the welding oil are avoided. The life time and the reliability of the contact image sensor are also enhanced. Because the welding method is not adopted, the assembling process for the contact image sensor is simplified. Moreover, the pads 22, 22′, 22″ are merely located at one surface of the substrate 2 to electrically connect the pins 33, 33′, 33″, the substrate 2 can be a single-layer board and its cost is reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A contact image sensor structure, comprising:
a body having a first side surface and a second side surface that are opposite to each other, wherein the body has a pin slot that passes through the first side surface and the second side surface, the second side surface has a light source receiving slot, and the light source receiving slot links with the pin slot;
a substrate fastened onto the first side surface and covering the pin slot, wherein the substrate has a plurality of pads; and
a light source unit fastened in the pin slot and the light source receiving slot, wherein one end of the light source unit has a plurality of pins, and the pins pass through the pin slot and contact the pads of the substrate.

2. The contact image sensor structure as claimed in claim 1, wherein the pad is located at one side surface of the substrate, and one end of the pins contacts the pad.

3. The contact image sensor structure as claimed in claim 1, wherein one side of the substrate has a plurality of through holes, the pads are respectively located inside the through holes, the pins pass through the through holes, each of the pins has a base portion, the exterior of the base portion is connected with a plurality of contact braces, and the contact braces respectively contact the pads.

4. The contact image sensor structure as claimed in claim 3, wherein the contact braces include a first curved portion, a contact portion and a second curved portion, the first and the second curved portion extending away from the base portion in a curved manner, and the contact portion extends from the end of the first curved portion that is distant from the base portion to the end of the second curved portion that is distant from the base portion.

5. The contact image sensor structure as claimed in claim 1, wherein the pins include a base portion and a holding portion, the holding portion includes a first contact arm, a second contact arm and a third contact arm, the second contact arm is located between the first contact arm and the third contact arm, the pads are located at one side surface of the substrate, and the first contact arm or the third contact arm respectively contact the pads at one side of the substrate.

6. The contact image sensor structure as claimed in claim 5, wherein the second contact arm is adjacent to a side wall of the substrate.

7. The contact image sensor structure as claimed in claim 5, wherein a side wall of the substrate has a plurality of concave openings, and the second contact arms respectively are lodged in the openings.

8. The contact image sensor structure as claimed in claim 1, wherein the pins include a base portion and a holding portion, the holding portion includes a first contact arm, a second contact arm and a third contact arm, the second contact arm is located between the first contact arm and the third contact arm, the pads are located at two opposite side surfaces of the substrate, and both the first contact arm and the third contact arm contact the respective pads.

9. The contact image sensor structure as claimed in claim 8, wherein the second contact arm is adjacent to a side wall of the substrate.

10. The contact image sensor structure as claimed in claim 8, wherein a side wall of the substrate has a plurality of concave openings, and the second contact arms respectively extend into the openings.

11. The contact image sensor structure as claimed in claim 1, wherein the light source unit is glued and fastened in the pin slot and the light source receiving slot.

12. The contact image sensor structure as claimed in claim 1, wherein the second side surface has a lens receiving slot, and a rod lens is fastened by gluing in the lens receiving slot.

13. The contact image sensor structure as claimed in claim 1, wherein the first side surface has a substrate installing slot, one end of the pin slot is located in the substrate installing slot, a plurality of fastening columns protrude and are disposed in the substrate installing slot at intervals that is integrated with the body into one piece, and the fastening holes are assembled onto the fastening columns.

14. The contact image sensor structure as claimed in claim 1, wherein the pins are flexible.
